(19) United States
(12) Patent Application Publication
(10) Pub. No.: US 2019/0334998 A1
(43) Pub. Date: Oct. 31, 2019

(54) Sensor For Detecting Measured Values; Method, Device And Computer-Readable Storage Medium With Instructions For Processing Measured Values From A Sensor

(71) Applicant: Volkswagen Aktiengesellschaft, Wolfsburg (DE)

(72) Inventors: Stephan Max, Gifhorn (DE); Peter Baumann, Braunschweig (DE)

(73) Assignee: Volkswagen Aktiengesellschaft, Wolfsburg (DE)

(21) Appl. No.: 16/467,030

(22) PCT Filed: Nov. 8, 2017
(86) PCT No.: PCT/EP2017/078578

§ 371 Date: Jun. 5, 2019

(30) Foreign Application Priority Data
Dec. 19, 2016 (DE) 10 2016 225 436.7

(51) Int. Cl. H04L 29/08; H04L 29/06; H04W 12/06; H04W 12/00

(52) U.S. Cl. CPC H04L 67/12; H04W 12/009; H04W 12/0609; H04L 63/0823

(57) ABSTRACT

A sensor for detecting measured values, a method, a device and a computer-readable storage medium with instructions for processing measured values. In a first step, a measured value is detected by a sensor. The detected measured value is then signed with the assistance of a certificate assigned to the sensor and forwarded to a network. The signed measured value is transmitted to a recipient through the network. Using the certificate, a check of the authenticity of the measured value by the recipient then occurs.

### CROSS-REFERENCE TO RELATED APPLICATIONS

This application claims priority to German Application No. DE 10 2016 225 436.7, filed on Dec. 19, 2016 with the German Patent and Trademark Office. The contents of the aforesaid application are incorporated herein for all purposes.

### TECHNICAL FIELD

The present invention relates to a method, a device and a computer-readable storage medium with instructions for processing measured values from a sensor. In particular, the invention relates to a method, a device and a computer-readable storage medium with instructions for processing measured values from a sensor that render manipulation of the measured values by third parties difficult. The invention moreover relates to a sensor in which such a method is realized, as well as a motor vehicle in which such a method, such a device or such a sensor is used.

### BACKGROUND

In current motor vehicles, an increasing amount of data is collected as a result of digitalization. Given the increasing networking in the world of vehicles and the risk of undesirable high-profile hacker attacks on vehicles, safe transmission of the data is desirable. In addition, efforts in the field of data security in vehicles are also to be anticipated from lawmakers. In order for data to be safely transmitted by the vehicle and to not restrict the usefulness of the data, it is important for data not to be influenceable in an unauthorized manner by third parties. To accomplish this, all communication paths from the respective node to the next node are saved in the vehicle.

Against this background, the document DE 10 2014 001 270 A1 describes a system for protected data transmission in a motor vehicle. To transmit useful data, initially a first codeword is calculated using a transmission time value. Then the useful data are transmitted together with the first codeword to a recipient. The method continues with the calculation of a second codeword using a reception-side time value. If the first codeword and the calculated second codeword do not correspond, the useful data are flagged by the recipient.

It is, however, problematic if data have to be sent from a sensor to a backend outside of the vehicle, for example for further evaluation to detect traffic data or weather data. In this case, various communication nodes are traversed that each must be secured. This results in high costs.

### SUMMARY

An object of the invention is to present solutions for processing measured values from a sensor that economically renders manipulation of the measured values by third parties difficult.

This object is solved by a method, by a device, and by a computer-readable storage medium with instructions according to the independent claims. Various embodiments of the invention are the discussed in the dependent claims and the following description.

### BRIEF DESCRIPTION OF THE DRAWINGS

In the FIGS.:

FIG. 1 schematically shows a method for processing measured values from a sensor;

FIG. 2 shows a first embodiment of a device for processing a measured value;

FIG. 3 shows a second embodiment of a device for processing a measured value;

FIG. 4 schematically shows a sensor for detecting a measured value in which a solution as discussed herein is realized; and

FIG. 5 schematically shows a motor vehicle in which a solution as discussed herein is realized.

### DETAILED DESCRIPTION

According to one aspect, a method for processing measured values from a sensor comprises the steps:
detecting a measured value by the sensor;
signing the detected measured value with the assistance of a certificate assigned to the sensor; and
forwarding the signed measured value to a network.

According to another aspect, a device for processing measured values has:
a sensor for detecting a measured value;
a signature unit for signing the detected measured value with the assistance of a certificate assigned to the sensor; and
an output for forwarding the signed measured value to a network.

According to another aspect, a computer-readable storage medium contains instructions that, while being executed by a computer, cause the computer to execute the following steps for processing measured values from a sensor:
detecting a measured value by the sensor;
signing the detected measured value with the assistance of a certificate assigned to the sensor; and
forwarding the signed measured value to a network.

According to another aspect, a sensor for detecting a measured value has a memory in which at least one certificate assigned to the sensor for signing the measured value is saved.

In some embodiments, the measured values are directly signed in the sensor. This signing may be retained over the complete communication chain. The sensor may receive at least one certificate for this. This certificate is used in order to sign the measurements that are performed by the sensors before being sent. The signed measured value may be transmitted to the recipient, the authenticity of the measured value may then be first checked by the recipient using the certificate. In some embodiments, the certificate is identical for all sensors of a type. By doing so, it is ensured that the recipient cannot draw any conclusions about a specific sensor using the certificate check. Consequently, no privacy rights are affected by the transmission of the measured values to the recipient. Alternatively and in some embodiments, the certificate is an individual certificate, i.e., each sensor of a type is assigned an unambiguous, unique certificate. That way, the sensor from which data on a detected event is coming may be unambiguously determined. In this manner, it may be ensured that not all of the sensors of a type are insecure following the unauthorized decoding of a certificate by a third party. To guarantee privacy rights in this case as well, the signed measured values are in some embodiments initially transmitted to an intermediate station that checks the authenticity of the measured value using the certificate, and then signs the measured value with a certificate assigned to the intermediate station. The measured value anonymized in this way is then forwarded to the recipient. The recipient is thus again unable to draw any conclusions about a specific sensor.

According to some embodiments, the certificate is saved in a sensor memory. The required certificate for the sensor may for example be introduced in the context of producing the sensor and saved in the memory in a protected manner. By saving the certificate in an internal memory of the sensor, external access to the certificate is thus significantly hindered since the communication between the sensor and memory occurs entirely within the sensor. In some embodiments, the memory is a tamper-proof memory. Tamper protection may be achieved in that the memory only be used by the sensor to which it is assigned, and (read and write) access to the memory is otherwise impossible without destroying the sensor. Reading out the data saved there or an intentional modification by directly contacting the sensor is also impossible from the outside. This category includes, for example, flash memory and random-access memory (RAM), if it is located directly in the sensor, and accessing the sensor is impossible from outside the sensor, including by direct contact. Tamper protection can also be achieved by using read-only memory (ROM).

In some embodiments, the certificate is selected from a group of certificates assigned to the sensor. In addition to a single certificate, a group of certificates may also be used for signing. In this case and in some embodiments, all certificates of the group are saved in a sensor memory. Thus, the number of certificates within the group is minimized so that no conclusions may be drawn about specific sensors. The sensors in some embodiments randomly search for a corresponding certificate and retain it for the entire sensor run time. On the receiver's side, it may then be determined that data on a detected event are coming from different sensors. The only requirement for this is for the sensors to use different certificates. This way, influences by faulty sensors or distortions by third parties may be correspondingly better detected.

In further embodiments, the certificate assigned to the sensor may be exchanged. In some embodiments, it is possible to exchange the certificates at certain intervals in time in a software update. Because of that, it can be ensured that the certificates are only useful for a short duration even if they are decoded by third parties.

In some embodiments, the method, the device, or the sensor are used in an autonomously or manually controlled vehicle, in particular a motor vehicle.

Further features and aspects of the present invention will become apparent from the claims and the following description in conjunction with the FIGS.

In order to better understand the principles of the present technology, embodiments are explained in greater detail below based on the FIGS. It should be understood that the invention is not limited to these embodiments and that the features described may also be combined or modified without departing from the scope of the invention.

FIG. 1 schematically shows a method for processing measured values from a sensor. In a first step, a measured value is detected 10 by the sensor. Then the detected measured value is signed with the assistance of a certificate assigned to the sensor. The signed measured value is subsequently forwarded 12 to a network. The signed measured value may be transmitted 13 to a server through the network. The server checks 14 the authenticity of the measured value using the certificate.

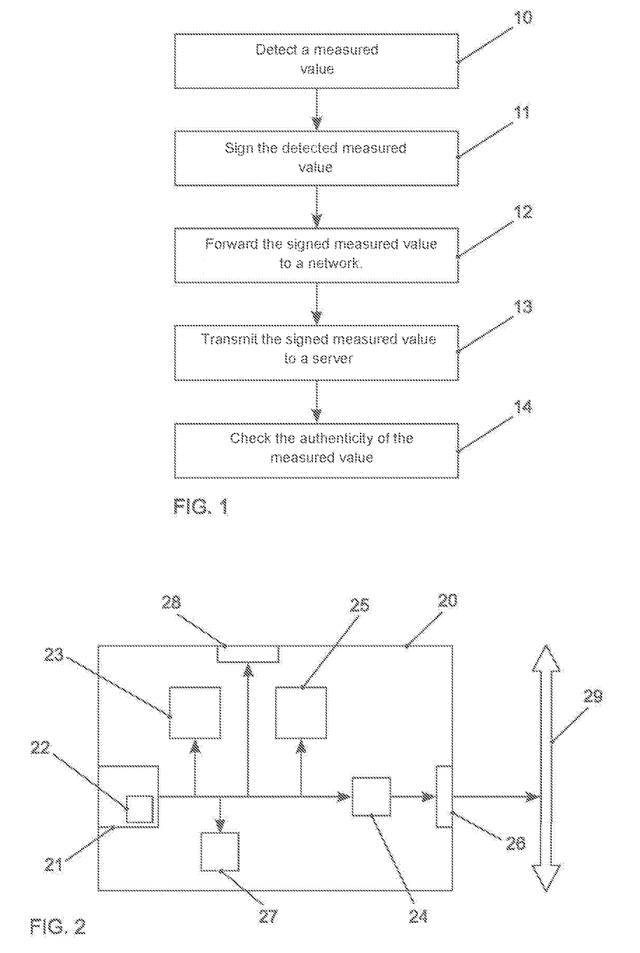

FIG. 2 shows a simplified schematic representation of a first embodiment of a device 20 for processing a measured value. The device 20 has a sensor 21 for detecting a measured value. A signature unit 23 signs the detected measured value with the assistance of a certificate assigned to the sensor 21. A communication unit 24 forwards the signed measured value via an output 26 of the device 20 to a network 29. The signature unit 23 and the communication unit 24 may be controlled by a control unit 25. The certificate used for signing may be saved in a memory 27 of the device. Optionally, the certificate may also be saved in a memory 22 within the sensor. Moreover, the signature unit 23, the communication unit 24 or the control unit 25 can also be an integral component of the sensor 21. If necessary, settings of the signature unit 23, the communication unit 24 or the control unit 25 may be changed by means of a user interface 28. The data arriving in the device 20 may also be saved in the memory 27 of the device 20, for example for a subsequent evaluation. The signature unit 23, the communication unit 24, as well as the control unit 25 may be realized as dedicated hardware, for example as integrated circuits. However, they may naturally also be implemented partially or completely combined or as software, which runs on a suitable processor.

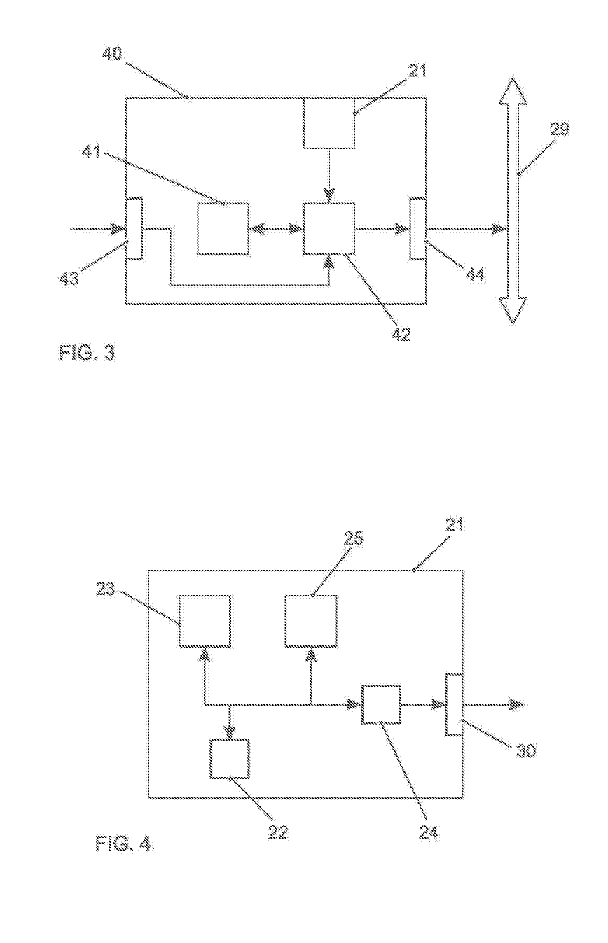

FIG. 3 shows a simplified schematic representation of a second embodiment of a device 40 for processing a measured value. The device 40 has a sensor 21 for detecting a measured value, a processor 42 and a memory 41. For example, the device 40 is a computer or controller. Instructions are saved in the memory 41 that, when executed by the processor 42, cause the device 40 to execute the steps according to one of the described methods. The instructions saved in the memory 41 thus represent a program that may be run by the processor 42 and that is realized by the method according to the present discussion. The device has an input 43 for receiving information. Data generated by the processor 42 are made available to a network 29 via an output 44. Moreover, said data may be saved in the memory 41. The input 43 and the output 44 may be combined into a bidirectional interface.

The processor 42 may comprise one or more processor units, for example microprocessors, digital signal processors or combinations thereof.

The memories 22, 27, 41 of the described embodiments may have volatile as well as non-volatile memory sections and may comprise a wide range of memory units and storage media, such as hard disks, optical storage media or semiconductor memories.

FIG. 4 schematically shows a sensor 21 for detecting a measured value. The sensor 21 has a memory 22 in which at least one certificate assigned to the sensor 21 for signing the measured value is saved. Moreover, a signature unit 23 is integrated in the sensor 21. The signature unit 23 signs the detected measured values with the assistance of the certificate assigned to the sensor 21. The signed measured values are output by a communication unit 24 via an interface 30. The signature unit 23 and the communication unit 24 can be controlled by a control unit 25. The signature unit 23, the communication unit 24 as well as the control unit 25 may be realized as dedicated hardware, for example as integrated circuits. However, they may naturally also be implemented partially or completely combined or as software, which runs on a suitable processor.

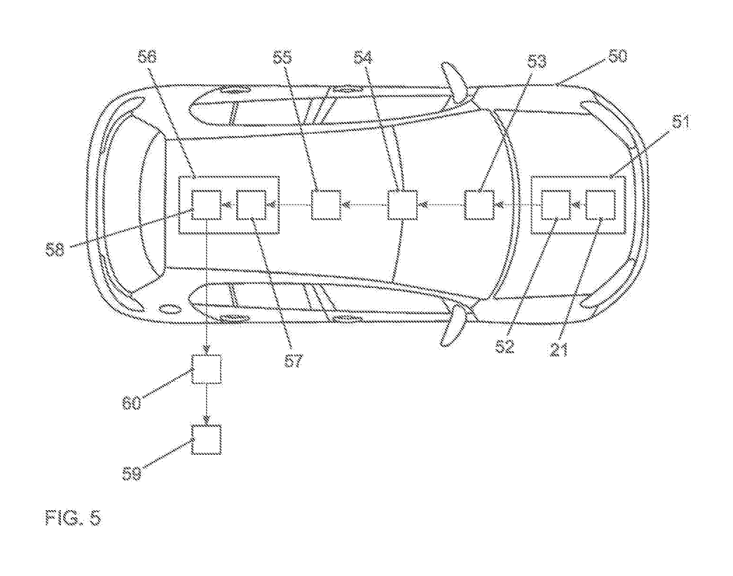

Another embodiment is described in detail below with reference to FIG. 5.

FIG. 5 schematically shows a motor vehicle 50 in which the method from FIG. 1 is realized. The vehicle has at least one sensor 21 that is assigned at least one certificate. This certificate is used to sign measurements of the sensor 21 before sending. The message signed in this manner passes through various nodes of a vehicle electrical system in the motor vehicle 50 before it is transmitted by a communication unit 56 to an external backend. In the example in FIG. 5, the data signed by the sensor 21 are forwarded from a communication processor 52 of a control unit 51 for the sensor 21 via a CAN (controller area network) A bus 53 to a vehicle gateway 54. From there, the data pass via a CAN B bus 55 to the communication unit 56 where they are received by another communication processor 57. A mobile communication processor 58 then assumes the transmission of the signed message to the recipient 59, i.e., the backend. The signing is then checked in the backend, i.e., the authenticity of the data is checked using the certificate. In the case of an individual certificate for the sensor 21, the signed message may for example be first transmitted to a secure intermediate station 60 that checks the authenticity of the message using the certificate. The message is then signed with a certificate assigned to the intermediate station 60 and only afterward is transmitted to the recipient 59.

The signing is independent of the bus system, i.e., the sensors are compatible with conventional bus systems such as CAN, CAN-FD (CAN with a flexible data rate) Ethernet, etc. Moreover, the signing is implemented such that it is sufficiently effective to be implemented in software on relatively weak processors. In other words, the signature calculation must be effectively implementable on all sensors so that the available calculation time in the sensor is not excessively restricted. Given a run time of the signature calculation of 100 μs, for example 10% of the available calculation time is no longer available for evaluating the measured values. Moreover, the required memory must be minimal for reasons of cost. It must moreover be taken into consideration that a majority of the input data has a length of ≤64 bytes. Many standard methods such as AES-CMAC (advanced encryption standard—cipher-based message authentication code) [1] or HMAC-SHA256 (HMAC-SHA: hash-based message authentication code—secure hash algorithm) [2] may not be used given these assumptions due to the code size or run time. Consequently, for example MACs (MAC: message authentication code) which are based on ChaCha20/12 [3] with a HAIFA construction (HAIFA: hash iterative framework) [4] are used. With this approach, values of <80 bytes state in RAM and <100 bytes state on the stack may be realized. Depending on the processor, the runtime is between 10 μs and 100 μs per call. One call is sufficient for amounts of useful data up to 32 bytes, an additional call for each additional 48 bytes. In comparison thereto, SHA-256 also requires at least two calls for data volumes of 32 bytes.

### REFERENCE NUMBER LIST

10 Detecting a measured value
11 Signing the detected measured value
12 Forwarding the signed measured value to network
13 Transmitting the signed measured value to a server
14 Checking the authenticity of the measured value
20 Device
21 Sensor
22 Memory
23 Signature unit
24 Communication unit
25 Control unit
26 Output
27 Memory
28 User interface
29 Network
30 Interface
40 Device
41 Memory
42 Processor
43 Input
44 Output
50 Motor vehicle
51 Control unit
52 Communication processor
53 CAN A bus
54 Vehicle gateway
55 CAN B bus
56 Communication unit
57 Communication processor
58 Mobile communications processor
59 Receiver
60 Intermediate station

### REFERENCES

[1] NIST: Recommendation for Block Cipher Modes of Operation: The CMAC Mode for Authentication, Special Publication 800-38B, Computer Security Publications from the National Institute of Standards and Technology (NIST)
[2] NIST: The Keyed-Hash Message Authentication Code (HMAC). FIPS PUB 198-1
[3] D. J. Bernstein: ChaCha, a variant of Salsa20, http://cr.yp.to/chacha.html
[4] E. Biham and O. Dunkelman: A Framework for Iterative Hash Functions—HAIFA, Proceedings of Second NIST Cryptographic Hash Workshop, 2006

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for processing measured values from a sensor, having the steps:
detecting a measured value by the sensor;
signing the detected measured value fusing a certificate assigned to the sensor that is saved in a memory of the sensor; and
forwarding the signed measured value from the sensor to a network.

2. The method according to claim 1, wherein the memory is a tamper-proof memory.

3. The method according to claim 1, wherein the certificate is an individual certificate.

4. The method according to claim 1, wherein the certificate is a certificate selected from a group of certificates assigned to the sensor.

5. The method according to claim 4, wherein the selected certificate is retained for the runtime of the sensor.

6. The method according to claim 1 with the following steps:
transmitting the signed measured value to a recipient; and
checking the authenticity of the measured value by the recipient using the certificate.

7. The method according to claim 6, wherein the signed measured value is checked in an intermediate station before being transmitted to the recipient and signed with a certificate assigned to the intermediate station.

8. The method according to claim 1, wherein the certificate assigned to the sensor may be exchanged.

9. The method according to claim 1, wherein the forwarding of the signed measured value from the sensor to a network is carried out via a bus system.

10. A non-transitory computer-readable storage medium with instructions that, when executed by a computer, cause the computer to conduct the steps of the method according to claim 1 for processing measured values from a sensor.

11. A sensor for detecting a measured value, wherein the sensor comprises:
a memory in which at least one certificate assigned to the sensor for signing the measured value is stored; and
a signature unit for signing a detected measured value with the assistance of the certificate assigned to the sensor.

12. The sensor according to claim 11, wherein the memory is a tamper-proof memory.

13. The sensor according to claim 11, wherein the sensor additionally has a communication unit for forwarding the signed measured value from the sensor to a network.

14. The sensor according to claim 13, wherein the communication unit for forwarding the signed measured value from the sensor to the network is compatible with a bus system that connects the sensor to the network.

15. A motor vehicle, comprising a sensor according to claim 11.

16. A motor vehicle, configured to execute a method according to claim 1 for processing measured values from a sensor.
